(19) United States
(12) Patent Application Publication
(10) Pub. No.: US 2005/0002052 A1
(43) Pub. Date: Jan. 6, 2005

(54) Printing method

(75) Inventor: Seung-Sik Yang, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/766,906

(22) Filed: Jan. 30, 2004

(30) Foreign Application Priority Data
Jul. 2, 2003 (KR) 2003-44538

(51) Int. Cl. G06F 15/00

(52) U.S. Cl. 358/1.13; 358/1.14

(57) ABSTRACT

This invention is related to a printing method and apparatus for recovering an error and a computer-readable recording medium for storing a computer program. The printing method includes storing intermediate data corresponding to a document to be printed, converting the intermediate data into printing data, determining whether an error has occurred while the intermediate data is converted into the printing data, and when determined that an error has occurred, converting the intermediate data into image type data and converting the image type data into the printing data. Here, the document is printed using the printing data.

### CROSS-REFERENCE TO RELATED APPLICATIONS

This application claims the priority of Korean Patent Application No. 2003-44538, filed on Jul. 2, 2003, in the Korean Intellectual Property Office, the disclosure of which is incorporated herein in its entirety by reference.

### BACKGROUND OF THE INVENTION

1. Field of the Invention

The present invention relates to printing, and more particularly, to a printing method and apparatus for recovering an error occurring when printing data to be provided to a printer is generated and a computer-readable recording medium for storing a computer program.

2. Description of the Related Art

When a document was prepared using an application program or the like in a host using WINDOWS, for example, as an operating system, document data corresponding to the document is converted into printing data in a printer driver of the host, before being transmitted to the printer. When the document data is converted into the printing data, an error such as a general protection fault (GPF) may occur. When a GPF occurs, the document data cannot be converted into the printing data. Moreover, when a cause of an error exists in the printer driver, another type of printer driver must be used to print the document data.

Consequently, since conventional printing methods use a different type of printer driver from an existing printer driver recovering an error occurring during data conversion, is somewhat inconvenient, or document data causing the error cannot be printed.

### SUMMARY OF THE INVENTION

The present invention provides a printing method for recovering an error occurring when printing data to be provided to a printer is generated so that a document is printed normally.

The present invention also provides a printing apparatus for recovering an error occurring when printing data to be provided to a printer is generated, thereby normally printing a document.

The present invention also provides a computer-readable recording medium for storing a computer program for recovering an error occurring when printing data to be provided to a printer is generated, thereby normally printing a document.

According to an aspect of the present invention, there is provided a printing method for recovering an error, comprising storing intermediate data corresponding to a document to be printed, converting the intermediate data into printing data, determining whether an error has occurred while the intermediate data is converted into the printing data, and when it is determined that an error has occurred, converting the intermediate data into image type data and converting the image type data into the printing data. Here, the document is printed using the printing data.

According to another aspect of the present invention, there is provided a printing apparatus for recovering an error, comprising a storage unit which stores intermediate data corresponding to a document to be printed; a printer driver which converts the intermediate data into printing data or, in response to a control signal, converts the intermediate data into image type data and then converts the image type data into the printing data; and a control unit, which inspects whether an error has occurred while the intermediate data is converted into the printing data, outputs a result of the inspection as the control signal, and in response to the control signal, loads the intermediate data from the storage unit and outputs the loaded intermediate data to the printer driver. Here, the document is printed using the printing data.

According to another aspect of the present invention, there is provided a computer-readable recording medium for storing a computer program for performing storing intermediate data corresponding to a document to be printed, converting the intermediate data into printing data, determining whether an error has occurred while the intermediate data is converted into the printing data, and when it is determined that an error has occurred, converting the intermediate data into image type data and converting the image type data into the printing data. Here, the document is printed using the printing data.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart of a printing method for recovering an error according to an embodiment of the present invention;

FIG. 2 is a block diagram of a printing apparatus for recovering an error according to an embodiment of the present invention; and

FIG. 3 is a block diagram of an embodiment of a control unit shown in FIG. 2.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Hereinafter, a printing method for recovering an error according to the present invention will be described with reference to the attached drawings.

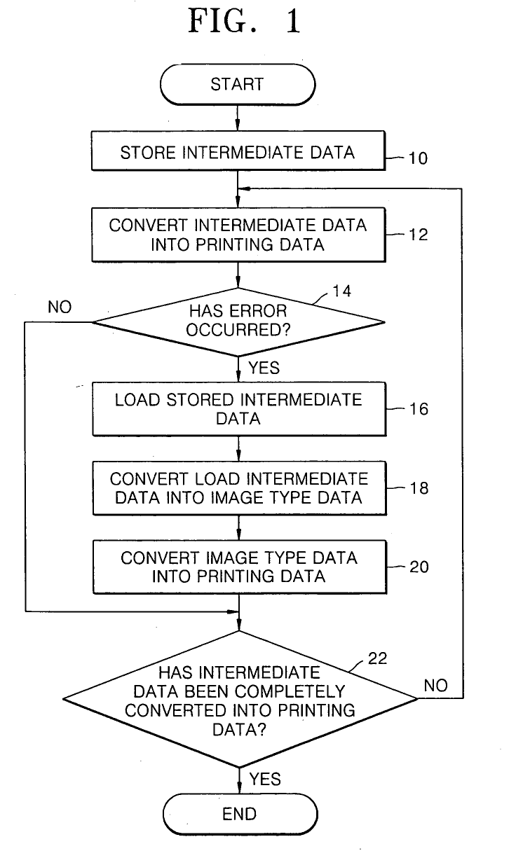

FIG. 1 is a flowchart of a printing method for recovering an error according to an embodiment of the present invention. The printing method includes converting intermediate data into printing data (10 and 12) and when an error occurs, converting the intermediate data into image type data and converting the image type data into printing data (14 through 22).

Referring to FIG. 1, intermediate data corresponding to a document to be printed is stored in operation 10. When WINDOWS, for example, is used as an operating system of a host (not shown) in which the document to be printed is generated using an application program, the intermediate data denotes one of graphic device interface (GDI) functions included in an enhanced meta file (EMF).

After operation 10, the intermediate data is converted into printing data in operation 12. The printing data may be described in a printer description language (PDL). The PDL is converted into bitmap data suitable for printing by a printer (not shown).

In operation 14, it is determined whether an error has occurred while the intermediate data is converted into the printing data. Usually, an error occurs due to a logical problem, which may occur when intermediate data is converted into printing data or due to a handling problem of a memory (not shown) used when intermediate data is converted into printing data. A general protection fault (GPF) is an example of such an error.

When it is determined that an error has occurred, the intermediate data is converted into image type data, and the image type data is converted into printing data in operations 16 through 20.

For example, when it is determined that an error has occurred, the stored intermediate data is loaded in operation 16. Thereafter, the loaded intermediate data is converted into image type data in operation 18. After operation 18, the image type data is converted into printing data in operation 20, and a document is printed using the printing data generated in operation 12 or 20.

Meanwhile, when it is determined that an error has not occurred in operation 14 or after operation 20, it is determined whether the intermediate data has been completely converted into the printing data in operation 22. In other words, it is determined that all GDI functions included in a stored single EMF have been completely converted into the printing data in operation 22. When it is determined that the intermediate data has not been completely converted into the printing data, the method goes back to operation 12. In other words, when it is determined that all of the GDI functions included in the EMF have not been converted into the printing data, the method goes back to operation 12 in order to convert a GDI function or GDI functions, i.e., intermediate data, that has not been converted into the printing data into the printing data. However, when it is determined that the intermediate data has been completely converted into the printing data, the method ends.

Hereinafter, a structure and an operation of a printing apparatus for recovering an error according to the present invention will be described with reference to the attached drawings.

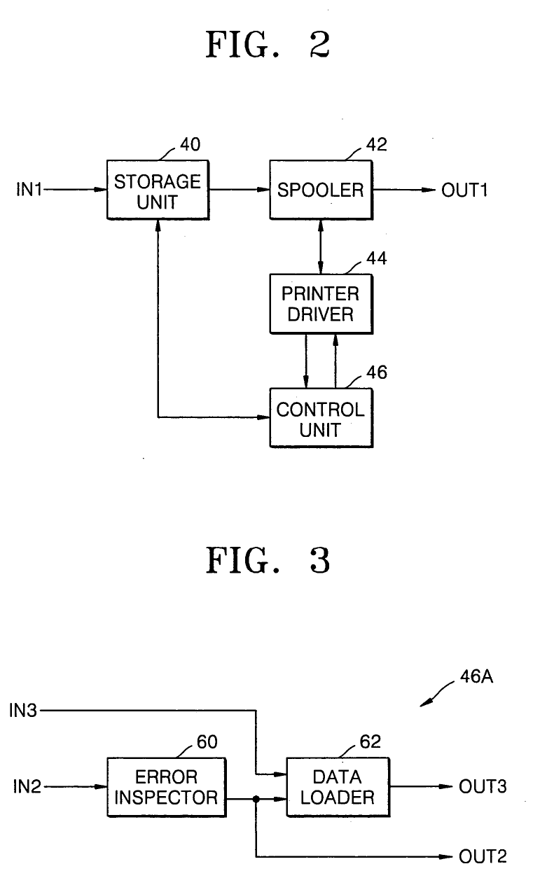

FIG. 2 is a block diagram of a printing apparatus for recovering an error according to an embodiment of the present invention. The printing apparatus includes a storage unit 40, a spooler 42, a printer driver 44, and a control unit 46. The printing apparatus performs the printing method shown in FIG. 1.

To perform operation 10, the storage unit 40 shown in FIG. 2 receives intermediate data corresponding to a document to be printed through an input terminal IN1 and stores the intermediate data. Then, the storage unit 40 reads the stored intermediate data in response to a request from the control unit 46 and outputs the read intermediate data to the control unit 46.

To perform operation 12, the printer driver 44 converts the intermediate data into printing data and outputs the printing data to the spooler 42. The spooler 42 outputs the printing data to a printer (not shown) or the like through an output terminal OUT1. Here, the spooler 42 is loaded with the intermediate data from the storage unit 40 and outputs the loaded intermediate data to the printer driver 44.

To perform operation 14, the control unit 46 inspects whether an error has occurred while the intermediate data is converted into the printing data in the printer driver 44 and outputs the result of the inspection as a control signal to the printer driver 44.

To perform operation 16, the control unit 46 is loaded with the intermediate data from the storage unit 40 in response to the control signal resulting from the inspection and outputs the loaded intermediate data to the printer driver 44. For example, when the control unit 46 recognizes that an error has occurred, the control unit 46 is loaded with intermediate data, which is being converted by the printer driver 44 at an instant in time when the error occurred, from the storage unit 40.

FIG. 3 is a block diagram of an embodiment 46A of the control unit 46 shown in FIG. 2. The embodiment 46A of the control unit 46 includes an error inspector 60 and a data loader 62.

To perform operation 14, the error inspector 60 inspects whether an error has occurred while the intermediate data is converted into the printing data and outputs the result of the inspection as a control signal to the data loader 62 and to the printer driver 44 through an output terminal OUT2. Here, the printer driver 44 can output an error signal reporting an error occurrence to the error inspector 60 when an error occurs while it is converting the intermediate data into the printing data. In this situation, the error inspector 60 inspects whether the error signal is received from the printer driver 44 through an input terminal IN2 and outputs the result of the inspection as a control signal.

To perform operation 16, in response to the control signal from the error inspector 60, the data loader 62 is loaded with the intermediate data from the storage unit 40 through an input terminal IN3 and outputs the loaded intermediate data to the printer driver 44 through an output terminal OUT3. For example, when an error occurrence is recognized through the control signal, the data loader 62 receives the intermediate data from the storage unit 40 and outputs the intermediate data to the printer driver 44 through the output terminal OUT3.

To perform operation 18, in response to the control signal received from the control unit 46, the printer driver 44 converts the intermediate data received from the control unit 46 into image type data. To perform operation 20, the printer driver 44 converts the image type data into printing data and outputs the printing data to the spooler 42. Then, the spooler 42 outputs the printing data from the printer driver 40 through the output terminal OUT1.

In order to perform operation 12, before inspecting for an error occurrence, the printer driver 44 converts the intermediate data from the spooler 42 into printing data according to characteristics such as a font or color. However, in order to perform operations 18 and 20, the occurrence of an error is recognized according to the control signal received from the control unit 46, the printer driver 44 converts the intermediate data received from the control unit 46, instead of the spooler 42, into image type data regardless of the characteristic and converts the image type data into printing data.

To perform operation 22, the control unit 46 inspects whether the intermediate data has been completely converted into the printing data by the printer driver 44 and outputs the result of the inspection as a conversion signal to the printer driver 44. Then, the printer driver 44 converts intermediate data that has not been converted into printing data into printing data in response to the conversion signal received from the control unit 46. For example, when it is considered that all of GDI functions included in an EMF have not been converted into printing data based on the conversion signal received from the control unit 46, the printer driver 44 converts a GDI function or GDI functions, i.e., the intermediate data that has not been converted, into printing data.

Meanwhile, the control unit 46 shown in FIG. 2 can control intermediate data to be stored in the storage unit 40. In addition, the printing apparatus for recovering an error according to the present invention, shown in FIG. 2, can be installed within a host generating a document to be printed.

Hereinafter, a computer-readable recording medium for storing a computer program for controlling a printing apparatus for recovering an error according to the present invention will be described.

The computer program stored in the computer-readable recording medium according to the present invention performs storing intermediate data corresponding to a document to be printed, converting the intermediate data into printing data, determining whether an error has occurred while converting the intermediate data into the printing data, and when it is determined that an error has occurred, converting the intermediate data into image type data, and converting the image type data into printing data. When it is determined that an error has not occurred or after the image type data is converted into the printing data, the computer program may further include determining whether the intermediate data has been completely converted into the printing data, and when it is determined that the intermediate data has not been completely converted into the printing data, converting remaining intermediate data into printing data.

When it is determined that an error has occurred, the computer program, which converts intermediate data into image type data and then converts the image type data into printing data, can perform loading stored intermediate data, converting the loaded intermediate data into image type data, and converting the image type data into printing data.

As described above, in the present invention, when an error occurs when intermediate data is converted into printing data, the intermediate data is converted into image type data, and the image type data is converted into printing data. Accordingly, the present invention automatically recovers the error occurring during data conversion without using an additional printer driver, thereby printing a document normally.

Although a few embodiments of the present invention have been shown and described, it would be appreciated by those skilled in the art that changes may be made in this embodiment without departing from the principles and spirit of the invention, the scope of which is defined in the claims and their equivalents.

1. A printing method for recovering an error, comprising:
storing intermediate data corresponding to a document to be printed;
converting the intermediate data into printing data;
determining whether an error has occurred while the intermediate data is converted into the printing data; and
in response to determining that an error has occurred, converting the intermediate data into image type data and converting the image type data into the printing data,
wherein the document is printed using the printing data.

2. The printing method of claim 1, further comprising:
in response to determining that an error has not occurred or after determining that an error has occurred, and the intermediate data has been converted into image type data and the image type data has been converted into the printing data, determining whether the intermediate data has been completely converted into the printing data; and
in response to determining that the intermediate data has not been completely converted into the printing data, going back to converting the intermediate data into the printing data.

3. The printing method of claim 1, wherein in response to determining that an error has occurred, loading the stored intermediate data;
converting the loaded intermediate data into the image type data; and
converting the image type data into the printing data.

4. The printing method of claim 1, wherein the error is a general protection fault type error.

5. A printing apparatus for recovering an error, comprising:
a storage unit storing intermediate data corresponding to a document to be printed;
a printer driver converting the intermediate data into printing data or, in response to a control signal, converting the intermediate data into image type data and then converting the image type data into the printing data; and
a control unit inspecting whether an error has occurred while the intermediate data is converted into the printing data, outputting a result of the inspection as the control signal, and in response to the control signal, loading the intermediate data from the storage unit and outputting the loaded intermediate data to the printer driver,
wherein the document is printed using the printing data.

6. The printing apparatus of claim 5, wherein the control unit inspects whether the intermediate data has been completely converted into the printing data by the printer driver, and outputs a result of the inspection as a conversion signal to the printer driver, and
the printer driver converts the intermediate data into the printing data in response to the conversion signal.

7. The printing apparatus of claim 5, wherein the control unit comprises:
an error inspector, which inspects whether an error has occurred while the intermediate data is converted into the printing data and outputs a result of the inspection as the control signal; and
a data loader, which in response to the control signal, loads the intermediate data from the storage unit and outputs the loaded intermediate data to the printer driver.

8. The printing apparatus of claim 5, further comprising a spooler loaded with intermediate data from the storage unit and outputting the loaded intermediate data to the printer driver, wherein the printer driver converts the intermediate data received from the spooler into the printing data.

9. A computer-readable recording medium storing a computer program comprising:
storing intermediate data corresponding to a document to be printed;
converting the intermediate data into printing data;
determining whether an error has occurred while the intermediate data is converted into the printing data; and
in response to determining that an error has occurred, converting the intermediate data into image type data and converting the image type data into the printing data,
wherein the document is printed using the printing data.

10. The computer-readable recording medium of claim 9, wherein the computer program further comprises:
in response to determining that an error has not occurred or after in response to determining that an error has occurred, determining whether the intermediate data has been completely converted into the printing data; and
in response to determining that the intermediate data has not been completely converted into the printing data, going back to converting the intermediate data into the printing data.

11. The computer-readable recording medium of claim 9, wherein:
in response to determining that an error has occurred, loading the stored intermediate data;
converting the loaded intermediate data into the image type data; and
converting the image type data into the printing data.

12. A printing method for recovering an error, comprising:
converting intermediate data into printing data;
determining whether an error has occurred while converting the intermediate data into the printing data;
converting the intermediate data into image type data and converting the image type data into the printing data if determined that an error has occurred;
determining if the intermediate data has been completely converted into the printing data; and
printing the document using the printing data if determined that the intermediate data has been completely converted into the printing data.

13. The printing method according to claim 12, wherein if determined that the intermediate data has not been completely converted into printing data, going back to converting the intermediate data into printing data.

14. The printing method according to claim 12, wherein the error is a general protection fault type error.

15. A printing apparatus for recovering an error, comprising:
a storage unit storing intermediate data corresponding to a document to be printed;
a printer driver converting the intermediate data into printing data; and
a control unit determining whether an error has occurred while the intermediate data is converted into the printing data, and in response to the determination, loading the intermediate data from the storage unit to the printer driver,
wherein the document is printed using the printing data.

16. The printing apparatus of claim 15, wherein the control unit inspects whether the intermediate data has been completely converted into the printing data by the printer driver, and outputs a result of the inspection as a conversion signal to the printer driver, and
the printer driver converts the intermediate data into the printing data in response to the conversion signal.

17. The printing apparatus of claim 15, wherein the control unit comprises:
an error inspector which inspects whether an error has occurred while the intermediate data is converted into the printing data and outputs a result of the inspection as a control signal; and
a data loader which in response to the control signal, loads the intermediate data from the storage unit and outputs the loaded intermediate data to the printer driver.

18. The printing apparatus of claim 15, further comprising a spooler loaded with intermediate data from the storage unit and outputting the loaded intermediate data to the printer driver, wherein the printer driver converts the intermediate data received from the spooler into the printing data.

19. A printing apparatus for recovering an error, comprising:
a storage unit storing intermediate data corresponding to a document to be printed;
a printer driver converting the intermediate data into image type data and then converting the image type data into printing data in response to a control signal; and
a control unit determining whether an error has occurred while the intermediate data is converted into the printing data, outputting a control signal according to the determination, and in response to the control signal, outputting the loaded intermediate data to the printer driver,
wherein the document is printed using the printing data.

20. The printing apparatus of claim 19, wherein the control unit inspects whether the intermediate data has been completely converted into the printing data by the printer driver, and outputs a result of the inspection as a conversion signal to the printer driver, and
the printer driver converts the intermediate data into the printing data in response to the conversion signal.
